(19) United States
(12) Patent Application Publication
(10) Pub. No.: US 2007/0196792 A1
(43) Pub. Date: Aug. 23, 2007

(54) Prefabricated Dental Crowns

(76) Inventors: Jason K. Johnson, Houston, TX (US); D. Johnson Krueger, Houston, TX (US)

Correspondence Address: MARK A OATHOUT, 3701 KIRBY DRIVE, SUITE 960, HOUSTON, TX, 77098, US

(21) Appl. No.: 11/677,574

(22) Filed: Feb. 21, 2007

Related U.S. Application Data
(60) Provisional application No. 60/775,168, filed on Feb. 21, 2006.

(51) Int. Cl. A61C 5/08

(52) U.S. Cl. 433/218

(57) ABSTRACT

Advanced material is preferably used for the manufacturing of dental crowns which may be used to restore decayed or to protect other compromised tooth structure. The dental crowns are preferably preformed or prefabricated with an undercut; tooth colored; for primary or permanent; anterior or posterior teeth; and may include internal metal or other strengthener(s). The undercut has an inwardly arcuate and angled taper toward the gingival end.

### CROSS-REFERENCE TO RELATED APPLICATIONS

This application claims the benefit of U.S. provisional application No. 60/775,168 filed Feb. 21, 2006.

### FEDERALLY SPONSORED RESEARCH OR DEVELOPMENT

Not applicable.

### REFERENCE TO LISTING, TABLES OR COMPACT DISK APPENDIX

Not applicable.

### SUMMARY

The term “advanced material” as used herein shall mean advanced, specialty, high performance, engineering plastics, thermoplastic—TPE or thermoset—TPV resins, polymers, copolymers, composites or compounds such as polyacetal, polyacrylate, polyamide, polyaryletherketone, polyetheretherketone—PEEK, polyetherimide, polyketone, polysulfone, ultra high molecular weight polyethylene—UHMWP(E) and other formulations, mixtures or mixtures thereof which may also include a filler or strengthening material.”

The term “undercut” as used herein shall mean the circumferential area of the dental crown being formed for mechanical retention.

The term “center surface” shall apply to both a surface of a dental crown consisting of an occlusal area or an incisal area depending on whether the respective dental crown is an anterior or a posterior dental crown.

Advanced material is preferably used for the manufacturing of dental crowns which may be used to restore decayed or to protect other compromised tooth structure. The dental crowns are preferably preformed or prefabricated with an undercut; tooth colored; for primary or permanent; anterior or posterior teeth; and may include internal metal or other strengthener(s). The undercut has an inwardly arcuate and angled taper toward the gingival end.

### BRIEF DESCRIPTION OF THE SEVERAL VIEWS OF THE DRAWINGS

FIG. 1 is an elevation, sectional view of a posterior embodiment of a dental crown bonded or cemented over a posterior tooth.

FIG. 2 is an elevation, sectional, side view of an anterior embodiment of a dental crown bonded or cemented over an anterior tooth.

FIG. 3 is a sectional view taken along line 3-3 of FIG. 2 save that the crown only is shown (no tooth, no cement).

FIG. 4 is a plan view of one embodiment of a strip for an anterior crown.

FIG. 5 is a plan view of another embodiment of a strip for a posterior crown.

FIG. 6 is a plan view of another embodiment of a strip.

FIG. 7 is a plan view of another embodiment of a strip.

FIG. 8 is a plan view of another embodiment of a strip.

FIG. 9 is sectional view of the dental crown of FIG. 1, without the cement and tooth, showing an embedded strip curled at the ends.

FIG. 10 is a breakaway of a dental crown embodiment having a powder coated layer from an advanced material.

### DESCRIPTION OF EMBODIMENT(S) SHOWN IN THE DRAWINGS

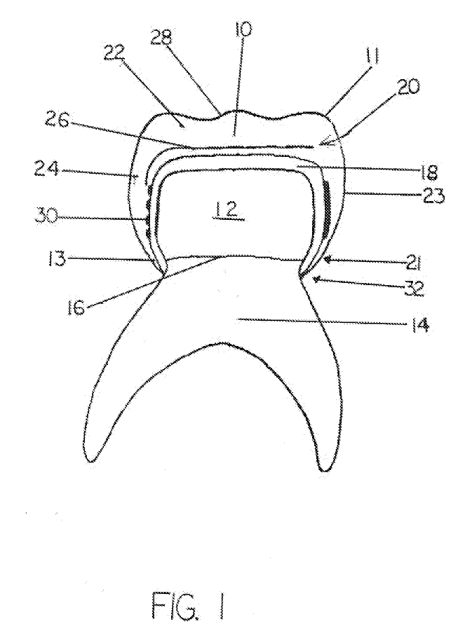

Referring to FIG. 1, a dental crown 10 made of advanced material is shown. The dental crown 10 could be manufactured of one-hundred percent advanced material or of mixtures thereof. The dental crown 10 may include internal compounded, mixed in or embedded strengthener(s) or fortification(s) 20. The strengthener(s) may be used or placed for localized strengthening or throughout the advanced material. The dental crown 10 is prefabricated in various sizes (for example, three to ten sizes per tooth 12). The various size dental crowns 10 are normally assembled into kits for primary or permanent dentition made available to dentists or the like. The advanced material may include barium sulfate for radiopacity or pigments for tinting to match common primary or permanent dentition shades.

A dentist will bond or cement the dental crown 10 to a tooth 12. The tooth 12 shown in FIG. 1 is a posterior tooth. Accordingly, the dental crown 10 shown in FIG. 1 is a posterior dental crown. The tooth 12 has a root 14 and emerges from the gums at the gum-line 16. A layer 18 of glass ionomer (“GI”) or other dental cement may be used by the dentist to apply and bond the dental crown 10 to the tooth 12 above and typically slightly below the gum-line 16 of the patient.

The exterior 11 of the dental crown 10 has an occlusal area (or surface) 22 transitioning into an integral circumferential area (or continuous wall) 24. Normally the circumferential area 24 has slight flexibility (although stiff) toward the gingival end 13 prior to application of the dental crown 10 to a tooth 12. The exterior 11 of the dental crown 10 is preferably toothlike or dentiform in appearance and shape.

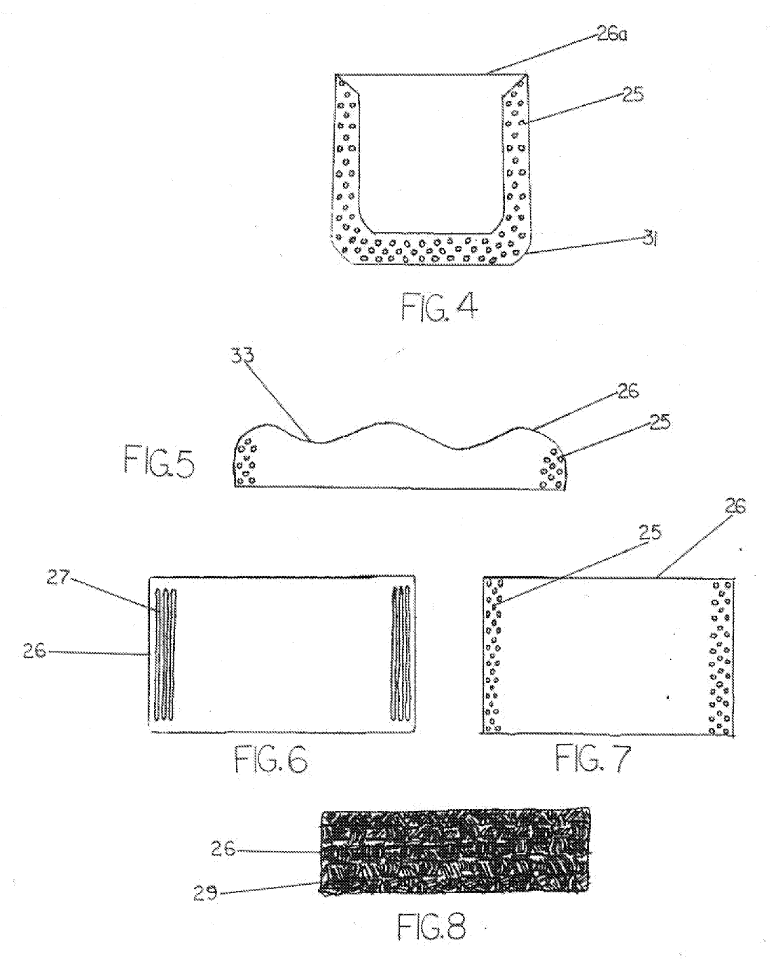

As mentioned, the dental crown 10 preferably includes one or more strengthener(s) 20. Strip 26 is one type of strengthener 20 and may be embedded in the occlusal area 22. Strip 26 depicts a metal, possibly stainless steel strip having a thickness of about/ranging 0.1-0.25 mm. The strip 26 could also be made of bio-compatible metals or non-metals, mesh/screen, fibers, woven fibers, aramids such as KEVLAR (a brand of material available from DuPont), preimpregnated carbon-polymer tapes or other bio-compatible material suitable for strength, and to prevent wear through from the opposing dentition. Strip(s) 26 may have perforations 25 or other retentive texturing 27 around the edges. The perforations 25 or texturing 27 may add flexibility to the strip 26. The strip(s) 26 may extend (see FIG. 6) into the interproximal and/or buccal/lingual circumferential area 24 of the crown 10 (i.e. contour with the surfaces 11 and/or 15 of the dental crown 10). The strips may have curved or straight edges or other configurations and shapes to accommodate the fit into the crown.

Accordingly the strengthener 20 may be chopped, short or continuous carbon fibers, glass fibers or particles, plastic, aramid or other fillers, particles or fibers 29 that are compounded or mixed in, embedded, laid-in, or affixed within the dental crown 10 The strengtheners 20 may be used or placed for localized strengthening or throughout the advanced material.

The occlusal area 22 has a total thickness ranging from 1.0 to 3.0 millimeters. In the embodiment shown in FIG. 1, the distance from the occlusal surface 28 to the strip 26 is, for example, about 0.75-2.0 millimeters. The strip(s) 26 may possibly be exposed on the internal surface (or cavern side 15) in one or more areas.

Grooves 30, indentations 30a and/or dimples 30b (only a few shown by way of example) may be created within the cavern side 15 (see FIG. 1 and FIG. 9) and/or internal circumferential area 24 of the dental crown 10. These grooves 30, indentations 30a and/or dimples 30b by way of example, may be arranged around the cavern side 15 of the internal circumferential area 24 respective to the sides of the tooth 12. The grooves 30, indentations 30a and/or dimples 30b add an enhanced surface for aiding in the bonding or cementing of the dental crown 10 to the tooth 12.

The external surface 11 of the circumferential area 24 of the crown 10 may have a crest (apex) 23 of contour. Regardless, the circumferential area 24 will taper toward the gingival end 13. If applicable, the crest 23 normally runs around the entire circumferential area 24. The taper 21 is inwardly arcuate (toward the gingival edge 32) in the normal case although not required. Near the gingival surface or edge 32 of the dental crown 10, toward the gingival taper 13, the total thickness of the advanced material ranges from 0.0-0.5 millimeters at the gingival edge 32, whilst the total thickness tapers outward to a range of about 1.0-3.0 millimeters proximate the occlusal area 22. The taper 21 may contour to undercut the tooth 12 near the gum-line 16 by from two to thirty-five degrees from a line vertical to the cavern side 15 of the dental crown 10. Such contour to undercut the tooth 12 near the gum-line 16 by from two to thirty-five degrees from a line vertical to the cavern side 15 may run around the entire circumferential area 24, but it may be limited to sections only of the circumferential area 24.

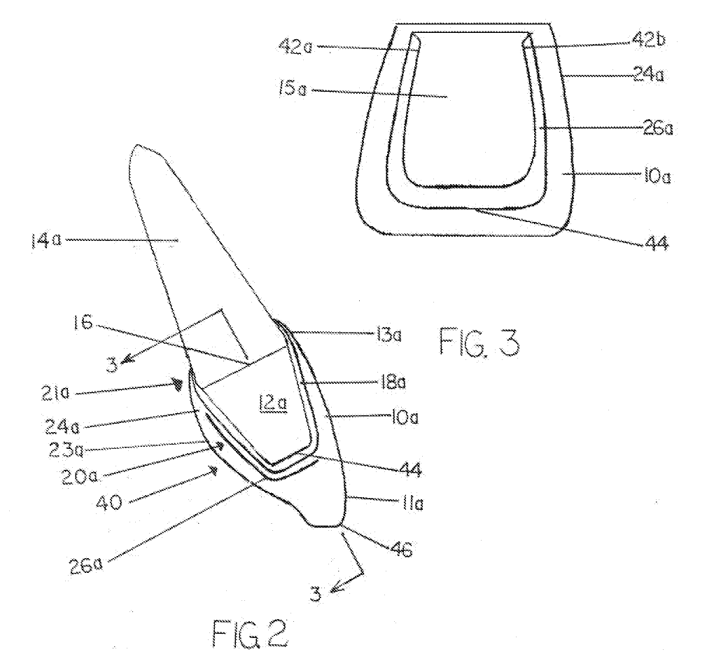

Referring to FIGS. 2-3, a dental crown 10a made of advanced material is shown. The exterior 11a of the dental crown 10a is preferably toothlike or dentiform in appearance and shape. The dental crown 10a may include internal compounded, mixed in or imbedded strengthener(s) 20a. The strengtheners 20a may be used or placed for localized strengthening or throughout the advanced material. The dental crown 10a is prefabricated in various sizes (for example, three to ten sizes per tooth 12a). The various size dental crowns 10a are normally assembled into kits for primary or permanent dentition made available to dentists or the like. The advanced material may include barium sulfate for radiopacity or pigments for tinting to match common primary or permanent dentition shades.

The exterior 11a of the dental crown 10a has an incisal area (or surface) 46 transitioning into an integral circumferential area (or continuous wall) 24a. Normally the circumferential area 24a has slight flexibility (although stiff) toward the gingival end 13a prior to application of the dental crown 10a to a tooth 12a.

A dentist will bond the dental crown 10a to a tooth 12a. The tooth 12a shown in FIG. 2 is an anterior tooth. Accordingly, the dental crown 10a shown in FIGS. 2-3 is an anterior dental crown. The tooth 12a has a root 14a and emerges from the gums at the gum-line (gingival edge) 16. A layer 18a of glass ionomer (“GI”) or other dental cement may be used by the dentist to apply and bond the dental crown 10a to the tooth 12a above and slightly below the gum-line 16 of the patient.

Strip 26a is one type of a strengthener to 20a and may be embedded in the dental crown 12a from the lingual back-side surface 40 and hooking around the incisal area 44, and possibly around the interproximal sides 42a and 42b. Strip 26a depicts a metal, possibly stainless steel strip having a thickness of about/ranging 0.1-0.25 mm. The strip 26a could also be made of bio-compatible metals, or non-metals, mesh/screen, fibers, woven fibers, aramids such as KEVLAR (a brand of material available from DuPont), preimpregnated carbon-polymer tapes or other bio-compatible material suitable for strength, and to prevent wear through from the opposing dentition.

Strip(s) 26a may have perforations 25 or other retentive texturing 27 around the edges. The perforations 25 or texturing 27 may add flexibility to the strip 26a. The strip(s) 26a may extend (see FIG. 2) into the interproximal, incisal, gingival and/or lingual circumferential area 24a of the crown 10a (i.e. contour with the surfaces 11a and/or 15a of the dental crown 10a). The strips may have curved or straight edges or other configurations and shapes to accommodate the fit into the crown.

Accordingly the strengthener 20a may be chopped, short or continuous carbon fibers, glass fibers or particles, plastic, aramid or other fillers, particles or fibers that are compounded or mixed in, embedded, laid-in, or affixed within the dental crown 10a. The strengtheners may be used or placed for localized strengthening or throughout the advanced material.

Grooves, indentations and/or dimples (not shown but the same in nature as described with respect to FIG. 9) may be created within the cavern side 15a (see FIG. 3) and/or internal circumferential area 24a of the dental crown 10a.

The external surface 11a of the circumferential area 24a of the crown 10a may have a crest (apex) 23a of contour on one or more sides. Regardless, the circumferential area 24a will taper toward the gingival end 13a. The taper 21a is inwardly arcuate in the normal case although not required. The incisal area 44 of the crown 10a has a total thickness ranging from 1.0 to 4.0 millimeters. In the embodiment shown in FIGS. 2-3, the distance from the incisal surface 46 and lingual back-side surface 40 to the nearest point of the strip 26a is about 0.75 millimeters. The strip(s) 26a may possibly be exposed on the internal surface (or cavern side 15a) in one or more areas. From the incisal area 44, the thickness of the dental crown 10a tapers down to the gum-line 16 (and may contour to undercut the tooth 12a near the gum-line 16). The total thickness of the advanced material ranges from 0.0-0.5 millimeters proximate the gum-line 16, whilst the total thickness tapers outward toward a range of about 1.0-4.0 millimeters. The taper 21a may contour to undercut the tooth 12a near the gum-line 16 by from two to thirty-five degrees from a line vertical to the cavern side 15a of the dental crown 10a (when the major axis of the dental crown 10a is vertical, albeit shown slanted in FIG. 2). Such contour to undercut the tooth 12a near the gum-line 16 by from two to thirty-five degrees from a line vertical to the cavern side 15a may run around the entire circumferential area 24a, but it may be limited to sections only of the circumferential area 24a.

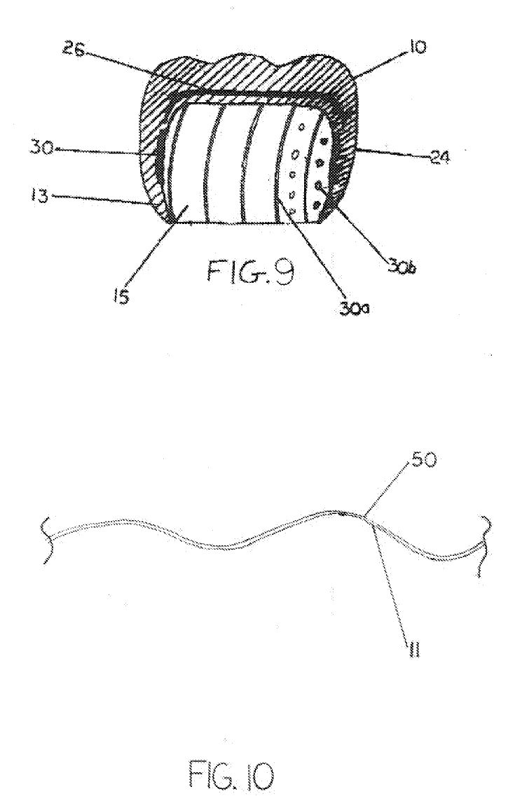

Other types of strengtheners 20 or 20a for strength, support, and/or to prevent wear through may be added to the dental crown 10 or 10a. It may be possible to exclude the strengthener(s) 20 or 20a from the respective dental crown 10 or 10a depending upon the characteristics of the material, fillers which may be added to the materials, adequate thickness in the chewing surface area of the crown and/or manufacturing techniques. Various embodiments or strips 26 or 26a are shown in FIGS. 4-8. Strips 26 and/or 26a may have rounded or chamfered corners 31 and edges. FIG. 5 shows an embodiment of a strip 26 having perforations 25 and having an occlusal contoured surface 33.

The dental crowns 10 and 10a may be produced in mass by any known means as one of ordinary skill in the area would be able to mass produce from compression molding, stamp forming, vacuum forming, injection molding, thermoforming, transfer molding, composite flow molding, machining or the like.

Advanced materials may be used or formulated as a powder coated layer 50 to be applied to all external surfaces 11, 11a, 15, and/or 15a of a dental crown 10 or 10a when such crown is a metal crown (see FIG. 10 where only surface 11 is shown, represented here as occlusal 22 but not limited thereto).

What is claimed is:

1. A dental crown, comprising:
a center surface;
a circumferential surface transitioning from and integral with the center surface wherein the circumferential surface includes a taper toward a gingival end; and
wherein said taper has a thickness ranging from 0 to about 0.5 millimeters at a gingival edge to at least about 1.0 millimeter proximate the transition to the center surface.

2. The apparatus according to claim 1, wherein the center surface and the circumferential surface define a cavern side of the dental crown and wherein said taper is angled on the cavern side at the gingival edge from two to thirty-five degrees from a line vertical to the cavern side of the dental crown.

3. The apparatus according to claim 1, wherein said taper is inwardly arcuate.

4. The apparatus according to claim 1, further including a strengthener in the dental crown.

5. The apparatus according to claim 4, wherein said strengthener comprises a strip.

6. The apparatus according to claim 5, wherein said strip is a metal strip having a thickness ranging from about 0.1 to about 0.25 millimeters.

7. The apparatus according to claim 5, wherein said strengthener is a strengthener selected from a group of materials consisting of metal, screen, mesh, fibers, woven fibers, carbon fibers, glass fibers, glass particles, plastic, aramids, preimpregnated carbon-polymer tapes and KEVLAR.

8. The apparatus according to claim 5, wherein said strip has perforations.

9. The apparatus according to claim 5, wherein said strip has texturing in a surface of said strip.

10. The apparatus according to claim 1, wherein the dental crown is made of an advanced material.

11. The apparatus according to claim 1, wherein the center surface and the circumferential surface define a cavern side of the dental crown; wherein said taper is angled on the cavern side at the gingival edge from two to thirty-five degrees from a line vertical to the cavern side of the dental crown; and wherein said taper is inwardly arcuate.

12. The apparatus according to claim 11, further including a metal strip embedded in the dental crown.

13. The apparatus according to claim 1, wherein the center surface and the circumferential surface define a cavern side of the dental crown; wherein the cavern side includes a means for enhancing the bond of the dental crown to a tooth.

14. The apparatus according to claim 13, wherein the bond enhancing means comprises a plurality of grooves.

15. The apparatus according to claim 13, wherein the bond enhancing means comprises a plurality of indentations.

16. A dental crown, comprising:
a center surface;
a circumferential surface transitioning from and integral with the center surface; and
a strengthener in the dental crown.

17. The apparatus according to claim 16, wherein said strengthener is a strip embedded in the dental crown.

18. The apparatus according to claim 17, wherein said strip is a metal strip having a thickness ranging from about 0.1 to about 0.25 millimeters.

19. The apparatus according to claim 16, wherein said strengthener is a strengthener selected from a group of materials consisting of metal, screen, mesh, fibers, woven fibers, carbon fibers, glass fibers, glass particles, plastic, aramids, preimpregnated carbon-polymer tapes and KEVLAR.

20. The apparatus according to claim 17, wherein said strip has perforations.

21. The apparatus according to claim 17, wherein said strip has texturing in a surface of said strip.

22. The apparatus according to claim 16, wherein the dental crown is made of an advanced material.

23. A method of making the dental crown according to claim 16, wherein the method of making is selected from a group of methods consisting of compression molding, stamp forming, vacuum forming, injection molding, thermoforming, transfer molding, composite flow molding and machining.

24. A method of making the dental crown according to claim 1, wherein the method of making is selected from a group of methods consisting of compression molding, stamp forming, vacuum forming, injection molding, thermoforming, transfer molding, composite flow molding and machining.
